(19) United States
(12) Patent Application Publication
(10) Pub. No.: US 2025/0070925 A1
(43) Pub. Date: Feb. 27, 2025

(54) METHODS AND APPARATUSES FOR ENHANCEMENTS OF FREQUENCY HOPPING FOR FULL DUPLEX

(71) Applicant: Lenovo (Beijing) Limited, Beijing (CN)

(72) Inventors: Yuantao Zhang, Beijing (CN); Ruixiang Ma, Beijing (CN); Hongmei Liu, Beijing (CN); Zhi Yan, Beijing (CN); Yingying Li, Beijing (CN); Haiming Wang, Beijing (CN)

(73) Assignee: Lenovo (Beijing) Limited, Beijing (CN)

(21) Appl. No.: 18/725,620

(22) PCT Filed: Dec. 30, 2021
(86) PCT No.: PCT/CN2021/143123

§ 371 Date: Jun. 28, 2024

(51) Int. Cl. H04L 5/00; H04L 5/14; H04W 72/21

(52) U.S. Cl. CPC H04L 5/0005; H04L 5/14; H04W 72/21

(57) ABSTRACT

Embodiments of the present application relate to methods and apparatuses of frequency hopping for full duplex (FD). According to an embodiment of the present application, a user equipment (UE) includes a processor and a transceiver coupled to the processor; and the processor of the UE is configured: to receive, via the transceiver of the UE from a network node, configuration information regarding frequency hopping for a subset of symbols or slots of a plurality of available symbols or slots in a time domain; and to determine, based on the configuration information regarding frequency hopping, a frequency hopping operation in the subset of symbols or slots for at least one of a physical uplink control channel (PUCCH) resource and a physical uplink shared channel (PUSCH) resource.

### TECHNICAL FIELD

Embodiments of the present application generally relate to wireless communication technology, in particular to methods and apparatuses of frequency hopping for full duplex (FD).

### BACKGROUND

In a wireless communication system, the term “duplex” means bidirectional communication between two devices, where the transmissions over the link in each direction may take place at the same time (i.e., full duplex (FD)) or mutual exclusive time (i.e., half duplex). In legacy FD transceiver, different carrier frequencies are employed for each link direction. This is referred to be FD frequency division duplex (FD-FDD). Conversely, in the case of half-duplex (HD) transceiver, the link directions are separated by time domain resources. When the same carrier frequency is used for each link direction, the HD transceiver is referred to be time division dual (TDD) system, while if different carrier frequencies are used, the system is known as half duplex FDD (HD-FDD).

In theory, a FD system has a potential to double the link throughput of its half-duplex counterparts. Besides, the transmission latency is also reduced due to bidirectional transmission in each time slot. Currently, details regarding frequency hopping for FD have not been discussed yet.

### SUMMARY

Some embodiments of the present application also provide a user equipment (UE). The UE includes a processor and a transceiver coupled to the processor; and the processor of the UE is configured: to receive, via the transceiver of the UE from a network node, configuration information regarding frequency hopping for a subset of symbols or slots of a plurality of available symbols or slots in a time domain; and to determine, based on the configuration information regarding frequency hopping, a frequency hopping operation in the subset of symbols or slots for at least one of a physical uplink control channel (PUCCH) resource and a physical uplink shared channel (PUSCH) resource.

In some embodiments, the subset of symbols or slots is configured with a FD operation. In some embodiments, the subset of symbols or slots may be determined by time division dual (TDD) configuration information.

In some embodiments, the configuration information regarding frequency hopping is carried in a PUCCH resource configured for symbols or slots outside of the subset of symbols or slots. In some other embodiments, the configuration information regarding frequency hopping is carried in a PUCCH resource configured for symbols or slots within the subset of symbols or slots.

In some embodiments, the configuration information regarding frequency hopping includes at least one of: a starting physical resource block (PRB) for a first hop within the subset of symbols or slots; or a second hop PRB for a second hop within the subset of symbols or slots.

In some embodiments, during determining the frequency hopping operation, the processor of the UE is configured to determine the starting PRB and the second hop PRB based on at least one of: a starting PRB configured for symbols or slots outside of the subset of symbols or slots; a second hop PRB configured for the symbols or slots outside of the subset of symbols or slots; and a size of a bandwidth part (BWP) configured for symbols or slots within the subset of symbols or slots, in response to the symbols or slots within the subset of symbols or slots configured with a FD operation.

In some embodiments, the processor of the UE is configured to perform the frequency hopping operation in the subset of symbols or slots based on an indication in uplink (UL) grant information.

In some embodiments, the configuration information regarding frequency hopping indicates enabling or disabling the frequency hopping operation for the subset of symbols or slots. For example, the processor of the UE may be configured to not perform the frequency hopping operation in symbols or slots within the subset of symbols or slots, in response to: the configuration information regarding frequency hopping indicating disabling the frequency hopping operation for the subset of symbols or slots; and the symbols or slots within the subset of symbols or slots being configured with a FD operation.

In some embodiments, during determining the frequency hopping operation, the processor of the UE is configured to determine a list of frequency hopping offsets used for the frequency hopping operation in the subset of symbols or slots based on at least one of: the configuration information regarding frequency hopping; or another list of frequency hopping offsets used by symbols or slots outside of the subset of symbols or slots, and a size of a BWP configured for the symbols or slots within the subset of symbols or slots, in response to the symbols or slots within the subset of symbols or slots configured with a FD operation.

In some embodiments, during determining the frequency hopping operation, the processor of the UE is configured to determine a starting physical resource block (PRB) for each hop in the subset of symbols or slots based on at least one of: the configuration information regarding frequency hopping; or a starting PRB indicated for symbols or slots outside of the subset of symbols or slots, and a size of a BWP configured for the symbols or slots within the subset of symbols or slots, in response to the symbols or slots within the subset of symbols or slots configured with a FD operation.

In some embodiments, the processor of the UE is configured to transmit data on the at least one of the PUCCH resource and the PUSCH resource via the transceiver of the UE to the network node.

Some embodiments of the present application provide a method, which may be performed by a UE. The method includes: receiving configuration information regarding frequency hopping for a subset of symbols or slots of a plurality of available symbols or slots in a time domain; and determining, based on the configuration information regarding frequency hopping, a frequency hopping operation in the subset of symbols or slots for at least one of a PUCCH resource and a PUSCH resource.

In some embodiments, the subset of symbols or slots is configured with a FD operation. In some embodiments, the subset of symbols or slots may be determined by TDD configuration information.

In some embodiments, the configuration information regarding frequency hopping is carried in a PUCCH resource configured for symbols or slots outside of the subset of symbols or slots. In some other embodiments, the configuration information regarding frequency hopping is carried in a PUCCH resource configured for symbols or slots within the subset of symbols or slots. In some embodiments, the configuration information regarding frequency hopping includes at least one of: a starting PRB for a first hop within the subset of symbols or slots; or a second hop PRB for a second hop within the subset of symbols or slots.

In some embodiments, during determining the frequency hopping operation, the method performed by the UE further includes determining the starting PRB and the second hop PRB based on at least one of: a starting PRB configured for symbols or slots outside of the subset of symbols or slots; a second hop PRB configured for the symbols or slots outside of the subset of symbols or slots; and a size of a BWP configured for symbols or slots within the subset of symbols or slots, in response to the symbols or slots within the subset of symbols or slots configured with a FD operation.

In some embodiments, the method performed by the UE further includes performing the frequency hopping operation in the subset of symbols or slots based on an indication in uplink (UL) grant information.

In some embodiments, the configuration information regarding frequency hopping indicates enabling or disabling the frequency hopping operation for the subset of symbols or slots. For example, the UE does not perform the frequency hopping operation in symbols or slots within the subset of symbols or slots, in response to: the configuration information regarding frequency hopping indicating disabling the frequency hopping operation for the subset of symbols or slots; and the symbols or slots within the subset of symbols or slots being configured with a FD operation.

In some embodiments, during determining the frequency hopping operation, the method performed by the UE further includes determining a list of frequency hopping offsets used for the frequency hopping operation in the subset of symbols or slots based on at least one of: the configuration information regarding frequency hopping; or another list of frequency hopping offsets used by symbols or slots outside of the subset of symbols or slots, and a size of a BWP configured for the symbols or slots within the subset of symbols or slots, in response to the symbols or slots within the subset of symbols or slots configured with a FD operation.

In some embodiments, during determining the frequency hopping operation, the method performed by the UE further includes determining a starting physical resource block (PRB) for each hop in the subset of symbols or slots based on at least one of: the configuration information regarding frequency hopping; or a starting PRB indicated for symbols or slots outside of the subset of symbols or slots, and a size of a BWP configured for the symbols or slots within the subset of symbols or slots, in response to the symbols or slots within the subset of symbols or slots configured with a FD operation.

In some embodiments, the method performed by the UE further includes transmitting data on the at least one of the PUCCH resource and the PUSCH resource to the network node.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned method performed by a UE.

Some embodiments of the present application also provide a network node (e.g., a base station (BS)). The network node includes a processor and a transceiver coupled to the processor; and the processor of the network node is configured: to transmit, via the transceiver of the network node to a UE, configuration information regarding frequency hopping for a subset of symbols or slots of a plurality of available symbols or slots in a time domain; and to receive, via the transceiver of the network node from the UE, data on at least one of a PUCCH resource and a PUSCH resource, wherein a frequency hopping operation in the subset of symbols or slots for the at least one of the PUCCH resource and the PUSCH resource is determined by the UE based on the configuration information regarding frequency hopping.

In some embodiments, the subset of symbols or slots is configured with a FD operation. In some embodiments, the subset of symbols or slots is determined by TDD configuration information.

In some embodiments, the configuration information regarding frequency hopping is carried in a PUCCH resource configured for symbols or slots outside of the subset of symbols or slots. In some other embodiments, the configuration information regarding frequency hopping is carried in a PUCCH resource configured for symbols or slots within the subset of symbols or slots.

In some embodiments, the configuration information regarding frequency hopping includes at least one of: a starting physical resource block (PRB) for a first hop within the subset of symbols or slots; or a second hop PRB for a second hop within the subset of symbols or slots. In some embodiments, the starting PRB and the second hop PRB are determined based on at least one of: a starting PRB configured for symbols or slots outside of the subset of symbols or slots; a second hop PRB configured for the symbols or slots outside of the subset of symbols or slots; and a size of a BWP configured for symbols or slots within the subset of symbols or slots, in response to the symbols or slots within the subset of symbols or slots configured with a FD operation.

In some embodiments, the configuration information regarding frequency hopping indicates enabling or disabling the frequency hopping operation for the subset of symbols or slots.

In some embodiments, a list of frequency hopping offsets used for the frequency hopping operation in the subset of symbols or slots is determined based on at least one of: the configuration information regarding frequency hopping; or another list of frequency hopping offsets used by symbols or slots outside of the subset of symbols or slots, and a size of a BWP configured for the symbols or slots within the subset of symbols or slots, in response to the symbols or slots within the subset of symbols or slots configured with a FD operation.

In some embodiments, a starting physical resource block (PRB) for each hop in the subset of symbols or slots is determined based on at least one of: the configuration information regarding frequency hopping; or a starting PRB indicated for symbols or slots outside of the subset of symbols or slots, and a size of a BWP configured for the symbols or slots within the subset of symbols or slots, in response to the symbols or slots within the subset of symbols or slots configured with a FD operation.

Some embodiments of the present application provide a method, which may be performed by a network node (e.g., a BS). The method includes: transmitting, to a UE, configuration information regarding frequency hopping for a subset of symbols or slots of a plurality of available symbols or slots in a time domain; and receiving, from the UE, data on at least one of a PUCCH resource and a PUSCH resource, wherein a frequency hopping operation in the subset of symbols or slots for the at least one of the PUCCH resource and the PUSCH resource is determined by the UE based on the configuration information regarding frequency hopping.

In some embodiments, the subset of symbols or slots is configured with a FD operation. In some embodiments, the subset of symbols or slots is determined by TDD configuration information.

In some embodiments, the configuration information regarding frequency hopping is carried in a PUCCH resource configured for symbols or slots outside of the subset of symbols or slots. In some other embodiments, the configuration information regarding frequency hopping is carried in a PUCCH resource configured for symbols or slots within the subset of symbols or slots.

In some embodiments, the configuration information regarding frequency hopping includes at least one of: a starting physical resource block (PRB) for a first hop within the subset of symbols or slots; or a second hop PRB for a second hop within the subset of symbols or slots. In some embodiments, the starting PRB and the second hop PRB are determined based on at least one of: a starting PRB configured for symbols or slots outside of the subset of symbols or slots; a second hop PRB configured for the symbols or slots outside of the subset of symbols or slots; and a size of a BWP configured for symbols or slots within the subset of symbols or slots, in response to the symbols or slots within the subset of symbols or slots configured with a FD operation.

In some embodiments, the configuration information regarding frequency hopping indicates enabling or disabling the frequency hopping operation for the subset of symbols or slots.

In some embodiments, a list of frequency hopping offsets used for the frequency hopping operation in the subset of symbols or slots is determined based on at least one of: the configuration information regarding frequency hopping; or another list of frequency hopping offsets used by symbols or slots outside of the subset of symbols or slots, and a size of a BWP configured for the symbols or slots within the subset of symbols or slots, in response to the symbols or slots within the subset of symbols or slots configured with a FD operation.

In some embodiments, a starting physical resource block (PRB) for each hop in the subset of symbols or slots is determined based on at least one of: the configuration information regarding frequency hopping; or a starting PRB indicated for symbols or slots outside of the subset of symbols or slots, and a size of a BWP configured for the symbols or slots within the subset of symbols or slots, in response to the symbols or slots within the subset of symbols or slots configured with a FD operation.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a network node (e.g., a BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1A illustrates a schematic diagram of a wireless communication system according to some embodiments of the present disclosure.

FIG. 1B illustrates two duplex modes according to some embodiments of the present disclosure.

FIG. 1C illustrates an exemplary slot format according to some embodiments of the present disclosure.

FIG. 1D illustrates an exemplary slot format and BWP for FD according to some embodiments of the present disclosure.

FIGS. 1E and 1F respectively illustrate PUSCH repetition type A and PUSCH repetition type B according to some embodiments of the present disclosure.

FIG. 1G illustrates an exemplary resource wastage case for PUCCH transmission with or without intra-slot frequency hopping in FD slots according to some embodiments of the present disclosure.

FIG. 1H illustrates an exemplary resource wastage case for PUCCH transmission with or without inter-slot frequency hopping in FD slots according to some embodiments of the present disclosure.

FIG. 2 illustrates an exemplary block diagram of an apparatus according to some embodiments of the present application.

FIGS. 3A, 3B, and 3C illustrate exemplary cases of PUCCH intra-slot frequency hopping in FD slots according to some embodiments of the present application.

FIGS. 4A, 4B, and 4C illustrate exemplary cases of PUCCH inter-slot frequency hopping in FD slots according to some embodiments of the present application.

FIG. 5 illustrates an exemplary case of frequency hopping for PUSCH repetition type B according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

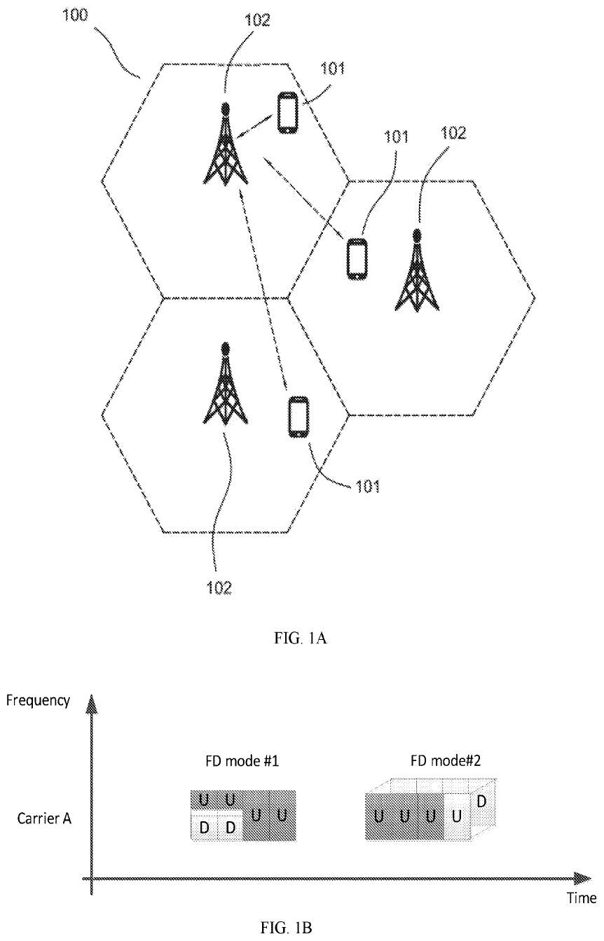

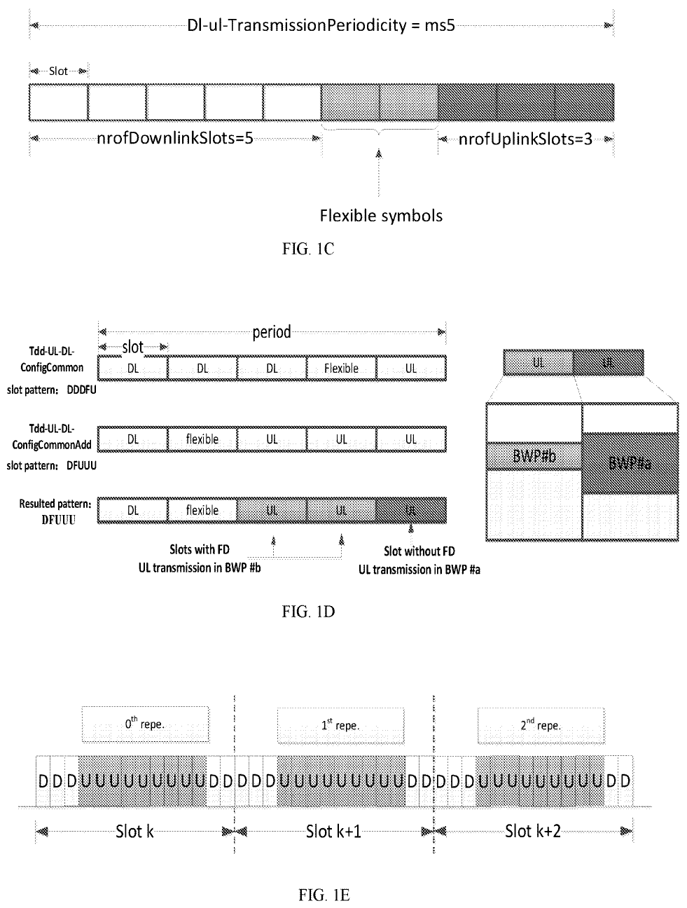

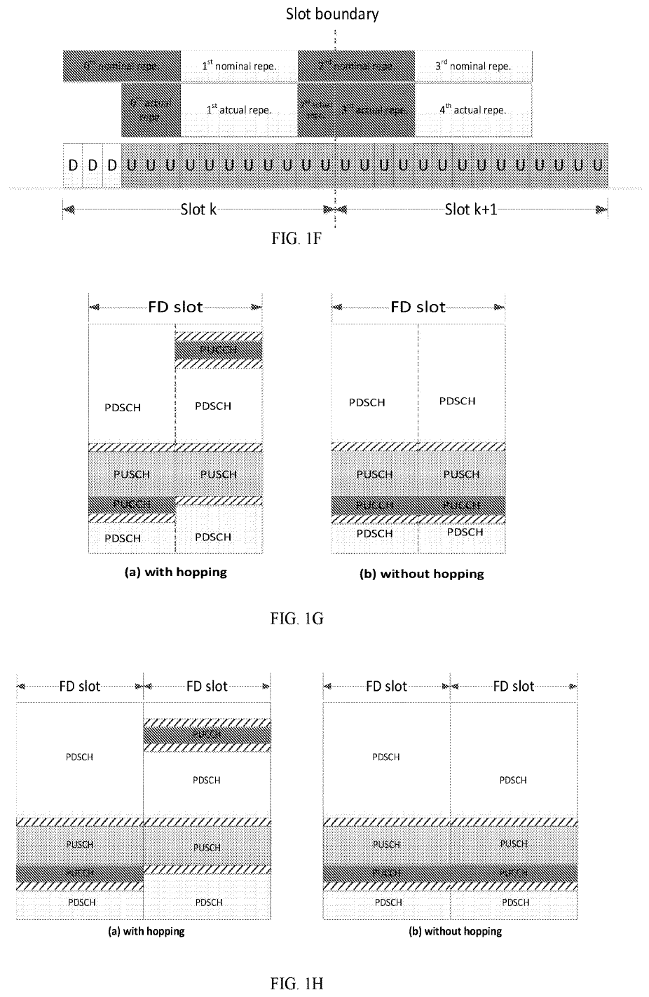

FIG. 1A illustrates a schematic diagram of a wireless communication system according to some embodiments of the present disclosure.

As shown in FIG. 1A, the wireless communication system 100 includes UE 101 and BS 102. In particular, the wireless communication system 100 includes three UEs 101 and three BSs 102 for illustrative purpose only. Even though a specific number of UEs 101 and BSs 102 are depicted in FIG. 1A, one skilled in the art will recognize that any number of UEs 101 and BSs 102 may be included in the wireless communication system 100.

The UEs 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, the UEs 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UEs 101 include wearable devices, such as smart watches, fitness bands, optical head-mounted displays, or the like. Moreover, the UEs 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UEs 101 may communicate directly with the BSs 102 via uplink (UL) communication signals.

The BSs 102 may be distributed over a geographic region. In certain embodiments, each of the BSs 102 may also be referred to as an access point, an access terminal, a base, a macro cell, a Node-B, an enhanced Node B (eNB), a gNB, a Home Node-B, a relay node, or a device, or described using other terminology used in the art. The BSs 102 are generally part of a radio access network that may include one or more controllers communicably coupled to one or more corresponding BSs 102.

The wireless communication system 100 is compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In one embodiment, the wireless communication system 100 is compatible with the 5G new radio (NR) of the 3GPP protocol, wherein the BSs 102 transmit data using an orthogonal frequency division multiplexing (OFDM) modulation scheme on the downlink and the UEs 101 transmit data on the uplink using Discrete Fourier Transform-Spread-Orthogonal Frequency Division Multiplexing (DFT-S-OFDM) or Cyclic Prefix-Orthogonal Frequency Division Multiplexing (CP-OFDM) scheme. More generally, however, the wireless communication system 100 may implement some other open or proprietary communication protocols, for example, WiMAX, among other protocols.

In other embodiments, the BSs 102 may communicate using other communication protocols, such as the IEEE 802.11 family of wireless communication protocols. Further, in some embodiments, the BSs 102 may communicate over licensed spectrums, whereas in other embodiments the BSs 102 may communicate over unlicensed spectrums. The present disclosure is not intended to be limited to the implementation of any particular wireless communication system architecture or protocol. In another embodiment, the BSs 102 may communicate with the UEs 101 using the 3GPP 5G protocols.

Duplex communication means bidirectional communication between two devices. There are two types of duplex communication, one is FD, which suggests that the transmissions over the link in each direction may take place at the same time, and the other is half duplex, which means that the transmissions over the link in each direction may take place at mutual exclusive time.

In general, FD modes enable simultaneous transmission and reception by the same device on the same carrier, which have potential to increase the link throughput than that in the legacy duplex modes. Besides, the transmission latency is also reduced thanks to bidirectional transmission in a time slot. Depending on if allowing overlapped DL/UL resource occupation, there are two FD modes, where for FD mode #1, the UL and DL occupy different frequency resources in a same carrier, while the FD mode #2, the UL and DL link could occupy overlapped resources. FIG. 1B illustrates these two duplex modes.

FIG. 1B illustrates two duplex modes according to some embodiments of the present disclosure. Simultaneous DL and UL in a same carrier will incur self-interference. Specifically, in a BS side, DL transmission might contaminate UL reception, while in a UE side, UL transmission might contaminate DL reception. Apparently, in FD mode #1 as shown in FIG. 1B, such self-interference level would be much lower than that in FD mode #2 as shown in FIG. 1B, thanks to the non-overlapped DL and UL resources. The self-interference could be further mitigated by introducing a gap in frequency domain between DL and UL, for FD mode #1 as shown in FIG. 1B, and by using more advanced interference cancellation receivers.

The FD enhances UL performance in terms of more UL resources (i.e., allocate part of resources in the conventional DL slot for UL transmission) for lower latency UL transmission in TDD system. The BS can allocate one set of UEs to use one set of frequency resource(s) for UL, while allocate another set of UEs to occupy another set of frequency domain resource(s) for DL, and the DL and UL resources are available simultaneously in time domain, but are not overlapped in frequency domain.

In general, a TDD slot format in 5G new radio (NR) includes downlink symbols, uplink symbols, and flexible symbols. The slot format might be determined by a cell common UL or DL configuration tdd-UL-DL-ConfigCommon, which is provided to the UE through system information and includes configurations of a set of DL slots/symbols, a set of UL slots/symbols and a set of flexible symbols.

FIG. 1C illustrates an exemplary slot format according to some embodiments of the present disclosure. In particular, FIG. 1C illustrates the slot format for the 10 slots with 5 ms dl-ul-TransmissionPeiodicity. nrofDownlinkSlots=5 indicates that the first 5 slots are DL slots. nrofUplinkSlots=3 indicates that the last 3 slots are UL slots. The remaining OFDM symbols in two slots may be flexible symbols.

To support FD in either a BS side or a UE side, as one alternative, the UE might be provided with a new set of TDD UL/DL configurations. For example, the UE may be provided with an additional cell specific configuration, named as tdd-UL-DL-ConfigCommonAdd. A UL symbol/slot indicated by tdd-UL-DL-ConfigCommonAdd could override a DL symbol/slot or a flexible symbol/slot indicated by tdd-UL-DL-ConfigCommon. Alternatively, the symbols/slots with FD can be indicated by the BS explicitly.

In frequency domain, a UL bandwidth part (BWP) might be configured and used in such symbols/slots for UL transmission. As a result, one UE can transmit UL signal in the configured UL BWP while another UE can receive DL signal simultaneously in a DL BWP, i.e., FD is achieved in such slots/symbols.

FIG. 1D illustrates an exemplary slot format and BWP for FD according to some embodiments of the present disclosure. FIG. 1D shows an example, in which a cell level slot pattern “DDDFU” is configured by tdd-UL-DL-ConfigCommon and another slot pattern “DFUUU” is configured by tdd-UL-DL-ConfigCommonAdd. The resulted cell level slot pattern is therefore “DFUUU”, i.e., Resulted pattern “DFUUU” as shown in FIG. 1D. UL BWP #b is used for UL transmission for slots/symbols that are DL or flexible but overridden by UL, while BWP #a is used for the UL slots/symbols in both configurations, as shown in FIG. 1D. In the slots/symbols with UL BWP #b, there might be UEs performing DL receptions simultaneously in a DL BWP.

Regarding NR PUCCH and PUSCH resources, a NR PUCCH resource is used for transmitting uplink control information (UCI), including, e.g., hybrid automatic repeat request-acknowledge (HARQ-ACK), a scheduling request (SR), and channel state information (CSI). A NR UE can be configured with one or more PUCCH resources for UCI reporting.

A PUCCH resource may be configured by RRC signaling PUCCH-Resource including following parameters:
A PUCCH resource index, pucch-ResourceId.
An index of the first PRB prior to frequency hopping or no hopping by startingPRB.
An index of the first PRB after frequency hopping by secondHopPRB.
An indication for intra-slot frequency hopping by intraSlotFrequencyHopping.
A configuration for a PUCCH format provided by format.

If intraSlotFrequencyHopping is configured as enabled, a UE transmits PUCCH in a first PRB starting from startingPRB in the first hop, and transmits PUCCH in a second PRB starting from secondHopPRB in the second hop. A UE can be configured up to 4 PUCCH resource sets for HARQ-ACK feedback. A PUCCH resource set is configured to include a set of PUCCH resources. It also includes a maximum number of UCI information bits that the UE can transmit using a PUCCH resource in the PUCCH resource set.

A PUCCH resource can be configured with N_rep={1, 2, 4, 8} repetitions. The UE repeats the PUCCH transmission with the UCI over N_rep slots. A PUCCH transmission in each of the N_rep slots has a same first symbol. A UE is configured by interslotFrequencyHopping whether or not to perform frequency hopping for PUCCH transmissions in different slots. If the UE is configured to perform frequency hopping for PUCCH transmissions across different slots, the UE performs frequency hopping per slot. The UE transmits the PUCCH starting from a first PRB, provided by startingPRB, in slots with even number and starting from the second PRB, provided by secondHopPRB, in slots with odd number. The UE does not expect to be configured to perform frequency hopping for a PUCCH transmission within a slot.

For a NR PUSCH resource, two repetition types have been defined:
1) For PUSCH repetition type A, the same symbol allocation is applied across the K consecutive slots. The UE shall repeat the PUSCH transport block across the K consecutive slots applying the same symbol allocation in each slot.
2) For PUSCH repetition type B, the UE is configured with L nominal repetitions. The UE firstly determine the invalid symbol(s) for each of the L nominal repetitions, and then, the remaining symbols are considered as valid symbols for PUSCH transmission. If the number of valid symbols is greater than zero for a nominal repetition, the nominal repetition consists of one or more actual repetitions, in which each actual repetition consists of a consecutive set of valid symbols that can be used for PUSCH repetition within a slot.

FIGS. 1E and 1F respectively illustrate PUSCH repetition type A and PUSCH repetition type B according to some embodiments of the present disclosure. In PUSCH repetition type A as shown in FIG. 1E, 0^{th} repetition is in UL symbols of Slot k, 1^{st} repetition is in UL symbols of Slot k+1, and 2^{nd} repetition is in UL symbols of Slot k+2. In PUSCH repetition type B as shown in FIG. 1F, 0^{th} nominal repetition corresponding to 0^{th} actual repetition and 1^{st} nominal repetition corresponding to 1^{st} actual repetition are in UL symbols of Slot k. 2^{nd} nominal repetition corresponds to two actual repetitions, i.e., 2^{nd} actual repetition in UL symbols of Slot k and 3^{rd} actual repetition in UL symbols of Slot k+1, as shown in FIG. 1F. 3^{rd} nominal repetition corresponding to 4^{th} actual repetition is in UL symbols of Slot k+1.

For PUSCH repetition type A as shown in FIG. 1E, either intra-slot frequency hopping or inter-slot frequency hopping can be configured by an RRC signaling. While for PUSCH repetition type B as shown in FIG. 1F, either inter-slot or inter-repetition frequency hopping can be configured. For both repetition types A and B, a frequency hopping flag is included in the UL-grant (scheduling DCI), indicating whether frequency hopping is enabled or disabled for PUSCH. The UL-grant also indicates a hopping offset RB_offset, which is chosen from a set of candidates that are configured by frequencyHoppingOffsetLists.

For PUSCH intra-slot frequency hopping, a UE transmits PUSCH in a first RB starting from RB_start in the first hop, and transmits PUSCH in a second PRB starting from mod(RB_start+RB_offset, N_BWP) in the second hop. The RB_start is given by frequency domain resource allocation in the UL-grant. N_BWP is the size of UL active BWP.

For PUSCH inter-slot frequency hopping, a UE transmits the PUSCH starting from a first PRB, provided by RB_start, in slots with even number and starting from the second PRB, provided by mod(RB_start+RB_offset, N_BWP), in slots with odd number.

For PUSCH inter-repetition frequency hopping, a UE transmits the PUSCH starting from a first PRB, provided by RB_start, in nominal repetition with even number and starting from the second PRB, provided by mod(RB_start+RB_offset, N_BWP), in nominal repetition with odd number.

Currently, compared with PUCCH or PUSCH transmission without hopping, there might be more resource wastage and more resource fragmentation when hopping is performed in FD system.

FIG. 1G illustrates an exemplary resource wastage case for PUCCH transmission with or without intra-slot frequency hopping in FD slots according to some embodiments of the present disclosure. FIG. 1H illustrates an exemplary resource wastage case for PUCCH transmission with or without inter-slot frequency hopping in FD slots according to some embodiments of the present disclosure. In FIG. 1G and FIG. 1H, rectangles with slashes are frequency gaps in the FD slots for mitigating interference between DL and UL. It is observed that more resources are needed for gaps when performing frequency hopping, which means more resource wastage.

Besides, if different BWPs are configured for FD symbols/slots and non-FD symbols/slots, hopping configuration(s) for non-FD symbols/slots might not be feasible for FD symbols, e.g., the BW between the configured first hop and the second hop might be wider than the BWP for FD symbols/slots. Lastly, with frequency hopping, it is more complex for inter-cell interference coordination since the transmission is dispersed in the frequency domain.

Embodiments of the present application aim to solve the above-mentioned issues. Specifically, in some embodiments of the present application, frequency hopping is separately configured for some of the symbols/slots, which are expected to be with FD operations. For instance, the configuration(s) may include enabling or disabling of frequency hopping for the FD symbols/slots. Such configuration(s) allows to configure enabling or disabling frequency hopping in FD symbols/slots and non-FD symbols/slots separately.

For configuration(s) of frequency hopping for a PUCCH resource, in some embodiments of the present application, separate configuration(s) for PUCCH frequency hopping in the FD symbols/slots are included in the existing PUCCH resource, while in some other embodiments of the present application, the configuration(s) for frequency hopping in FD symbols/slots are included in separate configured PUCCH resources for FD symbols/slots.

For PRB determination for each hop for a PUCCH resource, in some embodiments of the present application, the UE determines the starting PRB and second hop PRB in FD symbols/slots based on explicit and separate configuration(s), while in some other embodiments of the present application, the UE determines the starting PRB and second hop PRB in FD symbols/slots based on at least one of those configured for non-FD symbols/slots and the size of BWP configured for FD symbols/slots.

For enabling or disabling PUSCH frequency hopping for a PUSCH resource, in some embodiments of the present application, enabling or disabling PUSCH frequency hopping in FD symbols/slots is determined based on a RRC signalling. If PUSCH frequency hopping is configured as disabled by the RRC signalling, the UE will not perform frequency hopping in FD slots, even the UL-grant indicates to do so, while in some other embodiments of the present application, enabling or disabling PUSCH frequency hopping in FD slots is indicated separately in the UL-grant.

For configuration(s) of frequency hopping offset for a PUSCH resource, in some embodiments of the present application, the UE determines a list of frequency hopping offset for hopping in FD symbols/slots based on explicit and separate configuration(s), while in some other embodiments of the present application, the UE determines a list of frequency hopping offset for FD symbols/slots based on at least one of those configured for non-FD symbols/slots and the size of BWP configured for FD symbols/slots.

For starting RB determination for a PUSCH resource, in some embodiments of the present application, the UE determines the starting PRB for each hop in FD symbols/slots based on at least one of starting PRB indicated for non-FD symbols/slots and the size of BWP configured for FD symbols/slots.

In the embodiments of the present application, FD symbols/slots may also be named as “FD-symbols/slots”, “FD-symbols or slots”, “FD symbols or slots”, or the like, while non-FD symbols/slots may also be named as “non-FD-symbols or slots”, “FD symbols/slots not configured with a FD operation”, “FD symbols or slots not configured with a FD operation”, or the like, without departing from the spirit and scope of the disclosure.

More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

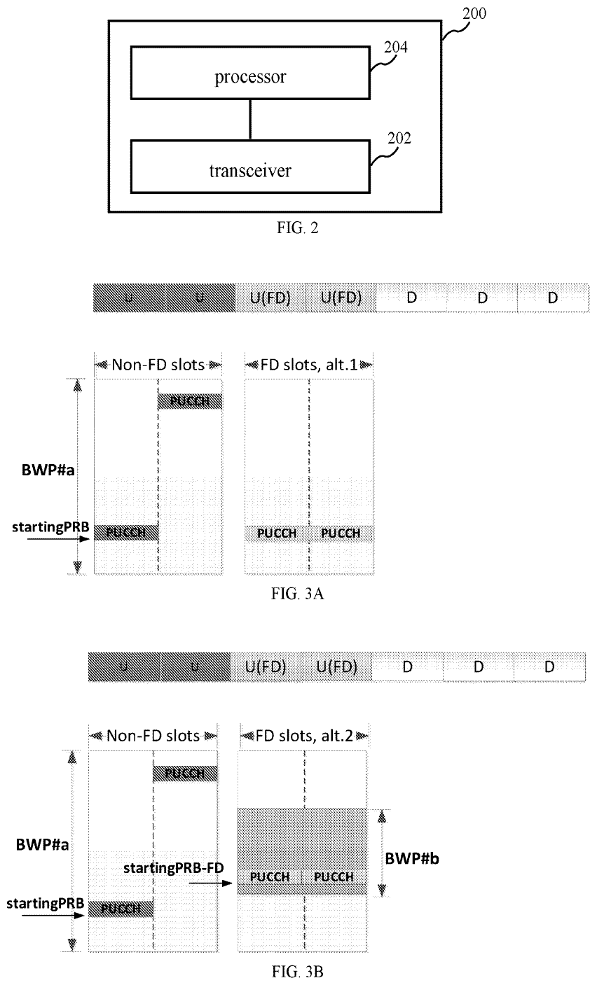

FIG. 2 illustrates an exemplary block diagram of an apparatus according to some embodiments of the present application. As shown in FIG. 2, the apparatus 200 may include at least one processor 204 and at least one transceiver 202 coupled to the processor 204. The at least one transceiver 202 may be a wired transceiver or a wireless transceiver. The apparatus 200 may be a UE or a network node (e.g., a BS).

Although in this figure, elements such as the at least one transceiver 202 and the processor 204 are described in the singular, the plural is contemplated unless a limitation to the singular is explicitly stated. In some embodiments of the present application, the transceiver 202 may be divided into two devices, such as a receiving circuitry and a transmitting circuitry. In some embodiments of the present application, the apparatus 200 may further include an input device, a memory, and/or other components.

In some embodiments of the present application, the apparatus 200 may be a UE (e.g., UE 101 as shown and illustrated in FIG. 1A). The processor 204 of the UE may be configured: to receive, via the transceiver 202 of the UE from a network node (e.g., BS 102 as shown and illustrated in FIG. 1A), configuration information regarding frequency hopping for a subset of symbols or slots of a plurality of available symbols or slots in a time domain; and to determine, based on the configuration information regarding frequency hopping, a frequency hopping operation in the subset of symbols or slots for at least one of a PUCCH resource and a PUSCH resource.

In some embodiments, the subset of symbols or slots is configured with a FD operation. In some embodiments, the subset of symbols or slots may be determined by TDD configuration information.

In some embodiments, the configuration information regarding frequency hopping is carried in a PUCCH resource configured for symbols or slots outside of the subset of symbols or slots. In some other embodiments, the configuration information regarding frequency hopping is carried in a PUCCH resource configured for symbols or slots within the subset of symbols or slots.

In some embodiments, the configuration information regarding frequency hopping includes at least one of: a starting PRB for a first hop within the subset of symbols or slots; or a second hop PRB for a second hop within the subset of symbols or slots.

In some embodiments, during determining the frequency hopping operation, the processor 204 of the UE is configured to determine the starting PRB and the second hop PRB based on at least one of: a starting PRB configured for symbols or slots outside of the subset of symbols or slots; a second hop PRB configured for the symbols or slots outside of the subset of symbols or slots; and a size of a BWP configured for symbols or slots within the subset of symbols or slots, in response to the symbols or slots within the subset of symbols or slots configured with a FD operation.

In some embodiments, the processor 204 of the UE is configured to perform the frequency hopping operation in the subset of symbols or slots based on an indication in UL grant information.

In some embodiments, the configuration information regarding frequency hopping indicates enabling or disabling the frequency hopping operation for the subset of symbols or slots. For example, the processor 204 of the UE may be configured to not perform the frequency hopping operation in symbols or slots within the subset of symbols or slots, in response to: the configuration information regarding frequency hopping indicating disabling the frequency hopping operation for the subset of symbols or slots; and the symbols or slots within the subset of symbols or slots being configured with a FD operation.

In some embodiments, during determining the frequency hopping operation, the processor 204 of the UE is configured to determine a list of frequency hopping offsets used for the frequency hopping operation in the subset of symbols or slots based on at least one of: the configuration information regarding frequency hopping; or another list of frequency hopping offsets used by symbols or slots outside of the subset of symbols or slots, and a size of a BWP configured for the symbols or slots within the subset of symbols or slots, in response to the symbols or slots within the subset of symbols or slots configured with a FD operation.

In some embodiments, during determining the frequency hopping operation, the processor 204 of the UE is configured to determine a starting PRB for each hop in the subset of symbols or slots based on at least one of: the configuration information regarding frequency hopping; or a starting PRB indicated for symbols or slots outside of the subset of symbols or slots, and a size of a BWP configured for the symbols or slots within the subset of symbols or slots, in response to the symbols or slots within the subset of symbols or slots configured with a FD operation.

In some embodiments, the processor 204 of the UE is configured to transmit data on the at least one of the PUCCH resource and the PUSCH resource via the transceiver 202 of the UE to the network node.

In some embodiments of the present application, the apparatus 200 may be a network node (e.g., BS 102 as shown and illustrated in FIG. 1A). The processor 204 of the network node is configured: to transmit, via the transceiver 202 of the network node to a UE (e.g., UE 101 as shown and illustrated in FIG. 1A), configuration information regarding frequency hopping for a subset of symbols or slots of a plurality of available symbols or slots in a time domain; and to receive, via the transceiver 202 of the network node from the UE, data on at least one of a PUCCH resource and a PUSCH resource, wherein a frequency hopping operation in the subset of symbols or slots for the at least one of the PUCCH resource and the PUSCH resource is determined by the UE based on the configuration information regarding frequency hopping.

In some embodiments, the subset of symbols or slots is configured with a FD operation. In some embodiments, the subset of symbols or slots is determined by TDD configuration information.

In some embodiments, the configuration information regarding frequency hopping is carried in a PUCCH resource configured for symbols or slots outside of the subset of symbols or slots. In some other embodiments, the configuration information regarding frequency hopping is carried in a PUCCH resource configured for symbols or slots within the subset of symbols or slots.

In some embodiments, the configuration information regarding frequency hopping includes at least one of: a starting physical resource block (PRB) for a first hop within the subset of symbols or slots; or a second hop PRB for a second hop within the subset of symbols or slots. In some embodiments, the starting PRB and the second hop PRB are determined based on at least one of: a starting PRB configured for symbols or slots outside of the subset of symbols or slots; a second hop PRB configured for the symbols or slots outside of the subset of symbols or slots; and a size of a BWP configured for symbols or slots within the subset of symbols or slots, in response to the symbols or slots within the subset of symbols or slots configured with a FD operation.

In some embodiments, the configuration information regarding frequency hopping indicates enabling or disabling the frequency hopping operation for the subset of symbols or slots.

In some embodiments, a list of frequency hopping offsets used for the frequency hopping operation in the subset of symbols or slots is determined based on at least one of: the configuration information regarding frequency hopping; or another list of frequency hopping offsets used by symbols or slots outside of the subset of symbols or slots, and a size of a BWP configured for the symbols or slots within the subset of symbols or slots, in response to the symbols or slots within the subset of symbols or slots configured with a FD operation.

In some embodiments, a starting physical resource block (PRB) for each hop in the subset of symbols or slots is determined based on at least one of: the configuration information regarding frequency hopping; or a starting PRB indicated for symbols or slots outside of the subset of symbols or slots, and a size of a BWP configured for the symbols or slots within the subset of symbols or slots, in response to the symbols or slots within the subset of symbols or slots configured with a FD operation.

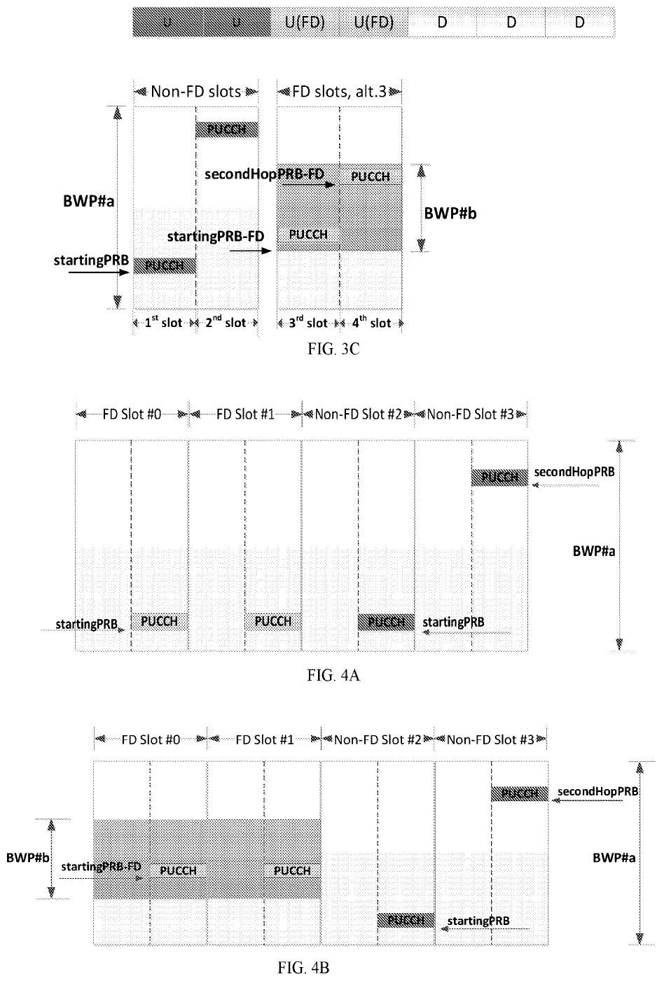

In some embodiments of the present application, the apparatus 200 may include at least one non-transitory computer-readable medium. In some embodiments of the present disclosure, the non-transitory computer-readable medium may have stored thereon computer-executable instructions to cause a processor to implement the method with respect to a UE or a network node (e.g., a BS) as described above. For example, the computer-executable instructions, when executed, cause the processor 204 interacting with the transceiver 202, so as to perform operations of the methods, e.g., as described in view of FIGS. 3-5.

According to some embodiments of the present application, for both PUCCH and PUSCH resources, frequency hopping is separately configured for some of the symbols/slots outside of whole symbols/slots, which are expected to be with FD operations (i.e., FD symbols/slots). A UE determines such symbols/slots based on either explicit configuration(s) from a BS, or implicitly from any other configuration(s), such as additional TDD configuration(s). For instance, the abovementioned configuration(s) may include enabling or disabling of frequency hopping for the FD symbols/slots. Such configuration(s) allows to configure enabling or disabling frequency hopping in FD symbols/slots and non-FD symbols/slots separately. In one example, frequency hopping might be configured in non-FD symbols/slots, but not in FD symbols/slots.

In some embodiments of the present application, a UE may determine RBs for a PUCCH or PUSCH resource for each hop in the FD symbols/slots. Details regarding frequency hopping operations for PUCCH and PUSCH in FD symbols/slots are as below.

Regarding PUCCH frequency hopping, there may be following three embodiments for the separate hopping configurations, i.e., Embodiments 1, 2, and 3.

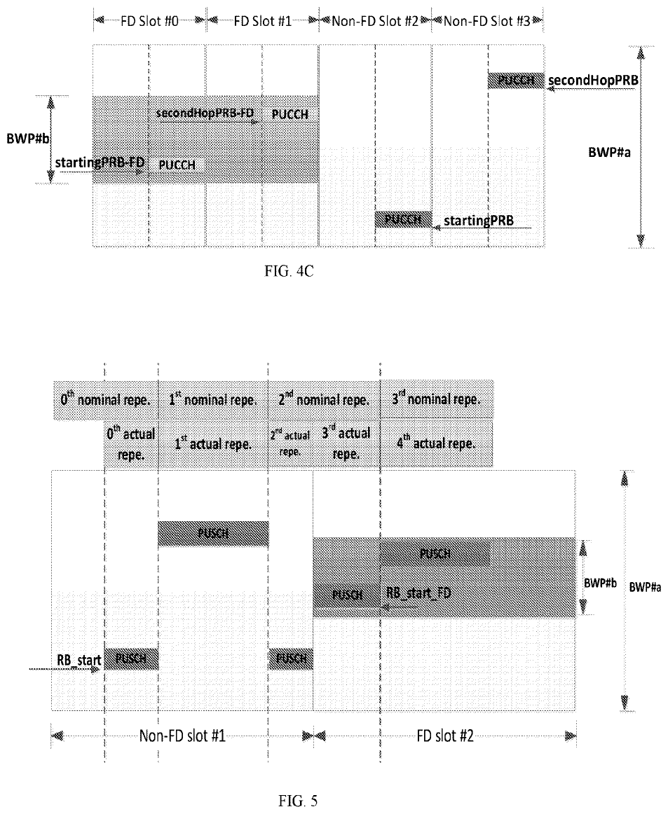

Embodiment 1 is for a case that FD symbols/slots and non-FD symbols/slots share the same UL BWP while a PUCCH resource set and a PUCCH resource set are also shared. In Embodiment 1, separate configurations for PUCCH frequency hopping in the FD symbols/slots are included in the existing PUCCH resource, which indicates “enabling or disabling intra-slot frequency hopping” or “enabling or disabling inter-slot frequency hopping in the FD symbols/slots”. The separate configurations might also include a starting PRB startingPRB-FD and second hop PRB secondHopPRB-FD for hopping in FD symbols/slots. Details of Embodiment 1 may include:
(1) If intra-slot PUCCH frequency hopping or inter-slot PUCCH frequency hopping is configured as disabled in FD slots, and if startingPRB-FD is not provided, a UE transmits PUCCH starting from a first RPB, provided by startingPRB in FD slots without frequency hopping. A specific example is described in the embodiment of “FD slots, alt. 1” as shown in FIG. 3A as follows.
(2) If intra-slot PUCCH frequency hopping or inter-slot PUCCH frequency hopping is configured as disabled in FD slots, and if startingPRB-FD is provided, a UE transmits PUCCH starting from a first RPB, provided by startingPRB-FD in FD slots without frequency hopping. A specific example is described in the embodiment of “FD slots, alt.2” as shown in FIG. 3B as follows.
(3) If intra-slot PUCCH frequency hopping is enabled, and a PUCCH repetition is not needed, and if startingPRB-FD and secondHopPRB-FD are provided, a UE transmits PUCCH starting from a first RPB, provided by startingPRB-FD for the first hop, and starting from the second PRB, provided by secondHopPRB-FD for the second hop, in FD slots. A specific example is described in the embodiment of “FD slots, alt.3” as shown in FIG. 3C as follows.
(4) If inter-slot PUCCH frequency hopping is enabled, and a PUCCH repetition is needed, and if startingPRB-FD and secondHopPRB-FD are provided, a UE transmits PUCCH starting from a first PRB, provided by startingPRB-FD, in FD slots with even number and starting from the second PRB, provided by secondHopPRB-FD, in FD slots with odd number. The UE transmits PUCCH starting from a first PRB, provided by startingPRB, in non-FD slots with even number and starting from the second PRB, provided by secondHopPRB, in non-FD slots with odd number. A specific example is described in the embodiments of FIG. 4C as follows.

In Embodiment 2, configuration(s) for frequency hopping in FD symbols/slots is included in separate configured PUCCH resources for FD symbols/slots, which includes “enabling or disabling intra-slot frequency hopping” or “enabling or disabling inter-slot frequency hopping” in the FD symbols slots. The configuration(s) might also include a starting PRB startingPRB-FD and a second hop PRB secondHopPRB-FD for hopping in FD symbols/slots. The separate configured PUCCH resources might be included in the configured BWP for FD symbols/slots.

For Embodiment 2, to facilitate inter-slot PUCCH frequency hopping, a PUCCH resource set for FD symbols/slots may be associated with a PUCCH resource set for non-FD symbols/slots with the same set index. PUCCH resources with the same index in the associated PUCCH resource sets are also associated. The parameters in a PUCCH resource set or a PUCCH resource set for FD symbols/slots, if not configured, can follow the configurations in the associated PUCCH resource or PUCCH resource set. When inter-slot frequency hopping is performed between FD symbols and non-FD symbols/slots, hopping is performed in PUCCH resources of FD symbols/slots and non-FD symbols/slots with the same PUCCH resource index of the same PUCCH resource set index, i.e., performed in the associated PUCCH resources. Details of Embodiment 2 may include:
(1) If intra-slot PUCCH frequency hopping or inter-slot PUCCH frequency hopping is configured as disabled in FD slots, and if startingPRB-FD is provided, a UE transmits PUCCH starting from a first RPB, provided by startingPRB-FD in FD slots without frequency hopping. A specific example is described in the embodiment of “FD slots, alt.2” as shown in FIG. 3B as follows.
(2) For the case that startingPRB-FD and secondHopPRB-FD are NOT provided, if intra-slot frequency hopping is enabled for the indicated PUCCH resource in FD slots, a UE transmits PUCCH starting from a first RPB, provided by startingPRB-FD=mod (startingPRB, N_BWP_FD) in the first hop, and starting from the second PRB, provided by secondHopPRB-FD=mod (secondHopPRB, N_BWP_FD) for the second hop, in the FD slots. N_BWP_FD is the size of BWP for FD slots, which might be the same or different with that for non-FD slots. The “mod( )” operation ensures the PUCCH is hopped within the configured BWP in FD slots. A specific example is described in the embodiment of “FD slots, alt.3” as shown in FIG. 3C as follows.
(3) For the case that startingPRB-FD and secondHopPRB-FD are provided, if intra-slot frequency hopping is enabled for the indicated PUCCH resource in FD slots, a UE transmits PUCCH starting from a first RPB, provided by startingPRB-FD in the first hop, and starting from the second PRB, provided by secondHopPRB-FD in the second hop, in the FD slots. A specific example is described in the embodiment of “FD slots, alt.3” as shown in FIG. 3C as follows.
(4) For the case that startingPRB-FD and secondHopPRB-FD are provided, when the UE performs inter-slot frequency hopping, if inter-slot frequency hopping is enabled in non-FD slots but not in FD slots, a UE transmits the PUCCH starting from a first PRB, provided by startingPRB, in non-FD slots with even number and starting from the second PRB, provided by secondHopPRB, in non-FD slots with odd number. The UE transmits the PUCCH starting from a first PRB, provided by startingPRB-FD, in FD slots. A specific example is described in the embodiments of FIG. 4B as follows.
(5) For the case that startingPRB-FD and secondHopPRB-FD are provided, when the UE performs inter-slot frequency hopping, if inter-slot frequency hopping is enabled in both non-FD slots and in FD slots, a UE transmits the PUCCH starting from a first PRB, provided by startingPRB, in non-FD slots with even number and starting from the second PRB, provided by secondHopPRB, in non-FD slots with odd number. The UE transmits the PUCCH starting from a first PRB, provided by startingPRB-FD, in FD slots with even number and starting from the second PRB, provided by secondHopPRB-FD, in FD slots with odd number. A specific example is described in the embodiments of FIG. 4C as follows.
(6) For the case that startingPRB-FD and secondHopPRB-FD are NOT provided, when the UE performs inter-slot frequency hopping, if inter-slot frequency hopping is enabled in non-FD slots but not in FD slots, a UE transmits the PUCCH starting from a first PRB, provided by startingPRB, in non-FD slots with even number and starting from the second PRB, provided by secondHopPRB, in non-FD slots with odd number. The UE transmits the PUCCH starting from a first PRB, provided by startingPRB-FD=mod (startingPRB, N_BWP_FD), in FD slots. A specific example is described in the embodiments of FIG. 4B as follows.
(7) For the case that startingPRB-FD and secondHopPRB-FD are NOT provided, when the UE performs inter-slot frequency hopping, if inter-slot frequency hopping is enabled in non-FD slots and in FD slots, a UE transmits the PUCCH starting from a first PRB, provided by startingPRB, in non-FD slots with even number and starting from the second PRB, provided by secondHopPRB, in non-FD slots with odd number. The UE transmits the PUCCH starting from a first PRB, provided by startingPRB-FD=mod (startingPRB, N_BWP_FD), in FD slots with even number and starting from the second PRB, provided by secondHopPRB-FD=mod(secondHopPRB, N_BWP_FD), in FD slots with odd number. A specific example is described in the embodiments of FIG. 4C as follows.
(8) For the case that startingPRB-FD and secondHopPRB-FD are NOT provided, when the UE performs inter-slot frequency hopping, if inter-slot frequency hopping is enabled in non-FD slots but not in FD slots, a UE transmits the PUCCH starting from a first PRB, provided by startingPRB, in non-FD slots with even number and starting from the second PRB, provided by secondHopPRB, in non-FD slots with odd number. The UE transmits the PUCCH starting from a first PRB, provided by startingPRB, in FD-slots. A specific example is described in the embodiments of FIG. 4A as follows.

For Embodiment 2, PUCCH in transmitted in the indicated PUCCH resource in non-FD symbols/slots, and transmitted in the associated PUCCH resource of the associated PUCCH resource set in FD symbols/slots.

In Embodiment 3, it is not expected from a UE side that frequency hopping is enabled in FD symbols/slots while disabled in non-FD symbols/slots. This is because that enabling frequency hopping in FD symbols/slots could bring a resource wastage issue, enabling frequency hopping in non-FD symbols/slots would not bring a resource wastage issue, and thus enabling frequency hopping in FD symbols/slots while disabling frequency hopping in non-FD symbols/slots would not bring any additional advantage.

Regarding PUSCH frequency hopping, in some embodiments, enabling or disabling PUSCH frequency hopping in FD symbols/slots is determined based on a RRC signalling. If PUSCH frequency hopping is configured as disabled by the RRC signalling, a UE will not perform frequency hopping in FD symbols/slots, even the UL-grant indicates to do so. In some other embodiments, enabling or disabling PUSCH frequency hopping in FD symbols/slots is indicated separately in the UL-grant.

Regarding PUSCH frequency hopping, in a case that FD symbols/slots and non-FD symbols/slots share a same UL BWP, a UE might be configured with a new RRC signalling frequencyHoppingOffsetLists-FD, which includes a list of candidate offsets for PUSCH inter-slot and inter-repetition hopping in FD symbols/slots. A BS selects one hopping offset and indicates the UE through DCI signalling. There may be following three embodiments for this case, i.e., Embodiments 4, 5, and 6.
(1) In Embodiment 4, when inter-slot PUSCH frequency hopping or inter-repetition PUSCH frequency hopping is configured as disabled in FD slots, a UE transmits PUSCH in FD slots starting from a first PRB, provided by RB_start without PUSCH frequency hopping.
(2) In Embodiment 5, when the UE performs inter-slot PUSCH hopping in FD slots, if frequencyHoppingOffsetLists-FD is configured, a UE transmits PUSCH starting from a first PRB, provided by RB_start in FD slots with even number and starting from the second PRB, provided by mod(RB_start+RB_offset_FD, N_BWP) in FD slots with odd number. The UE transmits PUSCH starting from a first PRB, provided by RB_start in non-FD slots with even number and starting from the second PRB, provided by mod(RB_start+RB_offset, N_BWP) in FD slots with odd number. RB_offset_FD is selected from frequencyHoppingOffsetLists-FD based on an indication in the UL grant.
(3) In Embodiment 6, when the UE performs inter-repetition PUSCH hopping in FD slots, if frequencyHoppingOffsetLists-FD is configured, a UE transmits PUSCH starting from a first PRB, provided by RB_start in FD slots with even nominal repetition number and starting from the second PRB, provided by mod(RB_start+RB_offset_FD, N_BWP) in FD slots with odd nominal repetition number. The UE transmits PUSCH starting from a first PRB, provided by RB_start in non-FD slots with even nominal repetition number and starting from the second PRB, provided by mod(RB_start+RB_offset, N_BWP) in FD slots with odd nominal repetition number. RB_offset_FD is selected from frequencyHoppingOffsetLists-FD based on an indication in the UL grant. From this scheme, when one nominal repetition includes multiple actual repetitions, the actual repetition in FD symbols and non-FD symbols might occupy different resources in frequency domain.

Regarding PUSCH frequency hopping, in a case that FD symbols/slots and non-FD symbols/slots are using different UL BWPs, a UE might be configured with a new RRC signalling frequencyHoppingOffsetLists-FD, which includes a list of candidate offsets for PUSCH inter-slot and inter-repetition hopping in FD symbols/slots. There may be following three embodiments for the case, i.e., Embodiments 7, 8, 9, 10, and 11.
(1) In Embodiment 7, when inter-slot PUSCH frequency hopping or inter-repetition frequency hopping is configured as disabled in FD slots, a UE transmits PUSCH starting from a first PRB, provided by mod(RB_start, N_BWP_FD) in FD slots without PUSCH frequency hopping. N_BWP_FD is the size of BWP configured for FD slots.
(2) In Embodiment 8, when the UE performs inter-slot PUSCH hopping in FD slots, if frequencyHoppingOffsetLists-FD is configured, a UE transmits PUSCH starting from a first PRB, provided by mod(RB_start, N_BWP_FD) in FD slots with even number and starting from the second PRB, provided by mod(RB_start+RB_offset_FD, N_BWP_FD) in FD slots with odd number. The UE transmits PUSCH starting from a first PRB, provided by RB_start in non-FD slots with even number and starting from the second PRB, provided by mod(RB_start+RB_offset, N_BWP) in non-FD slots with odd number.
(3) In Embodiment 9, when the UE performs inter-slot PUSCH hopping in FD slots, if frequencyHoppingOffsetLists-FD is NOT configured, a UE transmits PUSCH starting from a first PRB, provided by mod(RB_start, N_BWP_FD) in FD slots with even number and starting from the second PRB, provided by mod(RB_start+RB_offset, N_BWP_FD) in FD slots with odd number. The UE transmits PUSCH starting from a first PRB, provided by RB_start in non-FD slots with even number and starting from the second PRB, provided by mod(RB_start+RB_offset, N_BWP) in non-FD slots with odd number.
(4) In Embodiment 10, when the UE performs inter-repetition PUSCH hopping in FD slots, if frequencyHoppingOffsetLists-FD is configured, a UE transmits PUSCH starting from a first PRB, provided by mod(RB_start, N_BWP_FD) in FD slots with even nominal repetition number and starting from the second PRB, provided by mod(RB_start+RB_offset_FD, N_BWP_FD) in FD slots with odd nominal repetition number. The UE transmits PUSCH starting from a first PRB, provided by RB_start in non-FD slots with even nominal repetition number and starting from the second PRB, provided by mod(RB_start+RB_offset, N_BWP) in non-FD slots with odd nominal repetition number. A specific example is described in the embodiments of FIG. 5 as follows.
(4) In Embodiment 11, when the UE performs inter-repetition PUSCH hopping in FD slots, if frequencyHoppingOffsetLists-FD is NOT configured, a UE transmits PUSCH starting from a first PRB, provided by mod(RB_start, N_BWP_FD) in FD slots with even nominal repetition number and starting from the second PRB, provided by mod(RB_start+RB_offset, N_BWP_FD) in FD slots with odd nominal repetition number. The UE transmits PUSCH starting from a first PRB, provided by RB_start in non-FD slots with even nominal repetition number and starting from the second PRB, provided by mod(RB_start+RB_offset, N_BWP) in non-FD slots with odd nominal repetition number. From this scheme, when one nominal repetition includes multiple actual repetitions, the actual repetition in FD symbols and non-FD symbols might occupy different resources in frequency domain.

FIGS. 3A, 3B, and 3C illustrate exemplary cases of PUCCH intra-slot frequency hopping in FD slots according to some embodiments of the present application. FIGS. 3A, 3B, and 3C show a slot pattern “UUU(FD)U(FD)DDD”. Two non-FD slots correspond to two UL slots not configured with a FD operation, i.e., the first and second UL slots marked as “U”. Two FD slots correspond to two UL slots configured with a FD operation, i.e., the third and fourth UL slots marked as “U(FD)”. In the embodiments of FIGS. 3A, 3B, and 3C, a UE transmits PUCCH starting from a first RPB, provided by startingPRB in non-FD slots.

In particular, FIG. 3A shows an embodiment of “FD slots, alt.1”, in which BWP (i.e., BWP #a as shown in FIG. 3A) and PUCCH resources configured for non-FD slots are reused for FD slots, and PUCCH frequency hopping is disabled in FD slots. In this embodiment, if intra-slot PUCCH frequency hopping or inter-slot PUCCH frequency hopping is configured as disabled in FD slots, a UE transmits PUCCH starting from a first RPB, provided by startingPRB in FD slots without frequency hopping.

FIG. 3B shows an embodiment of “FD slots, alt.2”, in which separate BWP (i.e., BWP #a and BWP #b as shown in FIG. 3B) and PUCCH resources are configured for FD slots, and PUCCH frequency hopping is disabled in FD slots. In this embodiment, if intra-slot PUCCH frequency hopping or inter-slot PUCCH frequency hopping is configured as disabled in FD slots, a UE transmits PUCCH starting from a first RPB, provided by startingPRB-FD in FD slots without frequency hopping.

FIG. 3C shows an embodiment of “FD slots, alt.3”, in which separate BWP (i.e., BWP #a and BWP #b as shown in FIG. 3C) and PUCCH resources are configured for FD slots, and PUCCH frequency hopping is enabled in FD slots. In this embodiment, for the case that startingPRB-FD and secondHopPRB-FD are provided, if intra-slot PUCCH frequency hopping is enabled for the indicated PUCCH resource in FD slots, and a PUCCH repetition is not needed, a UE transmits PUCCH starting from a first RPB, provided by startingPRB-FD for the first hop, and starting from the second PRB, provided by secondHopPRB-FD) for the second hop, in FD slots.

In this embodiment of FIG. 3C, for the case that startingPRB-FD and secondHopPRB-FD are NOT provided, if intra-slot frequency hopping is enabled for the indicated PUCCH resource in FD slots, a UE transmits PUCCH starting from a first RPB, provided by startingPRB-FD=mod (startingPRB, N_BWP_FD) in the first hop, and transmits PUCCH starting from the second PRB, provided by secondHopPRB-FD=mod(secondHopPRB, N_BWP_FD) for the second hop, in the FD slots. N_BWP_FD is the size of BWP for FD slots, which might be the same or different with that for non-FD slots. The “mod( )” operation ensures the PUCCH is hopped within the configured BWP in FD slots.

Details described in all other embodiments of the present application (for example, details regarding frequency hopping for FD) are applicable for the embodiments of FIGS. 3A-3C. Moreover, details described in the embodiments of FIGS. 3A-3C are applicable for all embodiments of FIGS. 1A-2 and 4A-5.

FIGS. 4A, 4B, and 4C illustrate exemplary cases of PUCCH inter-slot frequency hopping in FD slots according to some embodiments of the present application. In these embodiments of FIGS. 4A-4C, four repetitions are configured for PUCCH repetition, and the PUCCH repetition happens in Slot #0 to Slot #3. Slot #0 and Slot #1 are FD slots, and Slot #2 and Slot #3 are non-FD slots.

In particular, FIG. 4A shows an embodiment that BWP (i.e., BWP #a as shown in FIG. 4A) and PUCCH resources of non-FD slots are reused for FD slots, and PUCCH frequency hopping is disabled in FD slots. In this embodiment, for the case that startingPRB-FD and secondHopPRB-FD are NOT provided, when a UE performs inter-slot frequency hopping, if inter-slot frequency hopping is enabled in non-FD slots but disabled in FD slots, a UE transmits the PUCCH starting from a first PRB, provided by startingPRB, in non-FD slots with even number (i.e., Non-FD slot #2 as shown in FIG. 4A) and starting from the second PRB, provided by secondHopPRB, in non-FD slots with odd number (i.e., Non-FD slot #3 as shown in FIG. 4A). The UE transmits the PUCCH starting from a first PRB, provided by startingPRB, in FD-slots (i.e., FD slot #0 and FD slot #1 as shown in FIG. 4A).

FIG. 4B shows an embodiment that separate BWP (i.e., BWP #a and BWP #b as shown in FIG. 4B) and PUCCH resources are configured for FD slot, and PUCCH frequency hopping is disabled in the FD slots. In this embodiment, for the case that startingPRB-FD) and secondHopPRB-FD are provided, when the UE performs inter-slot frequency hopping, if inter-slot frequency hopping is enabled in non-FD slots but disabled in FD slots, a UE transmits the PUCCH starting from a first PRB, provided by startingPRB, in non-FD slots with even number (i.e., Non-FD slot #2 as shown in FIG. 4B) and starting from the second PRB, provided by secondHopPRB, in non-FD slots with odd number (i.e., Non-FD slot #3 as shown in FIG. 4B). The UE transmits the PUCCH starting from a first PRB, provided by startingPRB-FD, in FD slots (i.e., FD slot #0 and FD slot #1 as shown in FIG. 4B).

In the embodiment of FIG. 4B, for the case that startingPRB-FD) and secondHopPRB-FD are NOT provided, when the UE performs inter-slot frequency hopping, if inter-slot frequency hopping is enabled in non-FD slots but disabled in FD slots, a UE transmits the PUCCH starting from a first PRB, provided by startingPRB, in non-FD slots with even number (i.e., Non-FD slot #2 as shown in FIG. 4B) and starting from the second PRB, provided by secondHopPRB, in non-FD slots with odd number (i.e., Non-FD slot #3 as shown in FIG. 4B). The UE transmits the PUCCH starting from a first PRB, provided by startingPRB-FD=mod(startingPRB, N_BWP), in FD slots (i.e., FD slot #0 and FD slot #1 as shown in FIG. 4B).

FIG. 4C shows an embodiment that separate BWP (i.e., BWP #a and BWP #b as shown in FIG. 4C) and PUCCH resources are configured for FD slot, and PUCCH frequency hopping is enabled in the FD slots. In this embodiment, if inter-slot PUCCH frequency hopping is enabled, and a PUCCH repetition is needed, a UE transmits PUCCH starting from a first PRB, provided by startingPRB-FD, in FD slots with even number (i.e., FD slot #0 as shown in FIG. 4C) and starting from the second PRB, provided by secondHopPRB-FD, in FD slots with odd number (i.e., FD slot #1 as shown in FIG. 4C). The UE transmits PUCCH starting from a first PRB, provided by startingPRB, in non-FD slots with even number (i.e., Non-FD slot #2 as shown in FIG. 4C) and starting from the second PRB, provided by secondHopPRB, in non-FD slots with odd number (i.e., Non-FD slot #3 as shown in FIG. 4C).

In the embodiment of FIG. 4C, for the case that startingPRB-FD and secondHopPRB-FD are provided, when a UE performs inter-slot frequency hopping, if inter-slot frequency hopping is enabled in both non-FD slots and in FD slots, the UE transmits the PUCCH starting from a first PRB, provided by startingPRB, in non-FD slots with even number (i.e., Non-FD slot #2 as shown in FIG. 4C) and starting from the second PRB, provided by secondHopPRB, in non-FD slots with odd number (i.e., Non-FD slot #3 as shown in FIG. 4C). The UE transmits the PUCCH starting from a first PRB, provided by startingPRB-FD, in FD slots with even number (i.e., FD slot #0 as shown in FIG. 4C) and starting from the second PRB, provided by secondHopPRB-FD, in FD slots with odd number (i.e., FD slot #1 as shown in FIG. 4C).

In the embodiment of FIG. 4C, for the case that startingPRB-FD and secondHopPRB-FD are NOT provided, when the UE performs inter-slot frequency hopping, if inter-slot frequency hopping is enabled in non-FD slots and in FD slots, a UE transmits the PUCCH starting from a first PRB, provided by startingPRB, in non-FD slots with even number (i.e., Non-FD slot #2 as shown in FIG. 4C) and starting from the second PRB, provided by secondHopPRB, in non-FD slots with odd number (i.e., Non-FD slot #3 as shown in FIG. 4C). The UE transmits the PUCCH starting from a first PRB, provided by startingPRB-FD=mod(startingPRB, N_BWP_FD), in FD slots with even number (i.e., FD slot #0 as shown in FIG. 4C) and starting from the second PRB, provided by secondHopPRB-FD=mod(secondHopPRB, N_BWP_FD), in FD slots with odd number (i.e., FD slot #1 as shown in FIG. 4C).

Details described in all other embodiments of the present application (for example, details regarding frequency hopping for FD) are applicable for the embodiments of FIGS. 4A-4C. Moreover, details described in the embodiments of FIGS. 4A-4C are applicable for all embodiments of FIGS. 1A-3C and 5.

FIG. 5 illustrates an exemplary case of frequency hopping for PUSCH repetition type B according to some embodiments of the present application. The embodiments of FIG. 5 use the time domain transmission pattern in FIG. 1F. The pattern in frequency domain is as shown in FIG. 5. It can be observed that 2^{nd} actual repetition and 3^{rd} actual repetition are started from different PRBs, although they are from the same nominal repetition, i.e., 2^{nd} nominal repetition as shown in FIG. 5. This is because of different BWPs (i.e., BWP #a and BWP #b as shown in FIG. 5) are used for non-FD slots and FD slots.

In the embodiments of FIG. 5, when a UE performs inter-repetition PUSCH hopping in FD slot #2, if frequencyHoppingOffsetLists-FD is configured, a UE transmits PUSCH starting from a first PRB, provided by mod(RB_start, N_BWP_FD) in FD slot #2 with even nominal repetition number (i.e., 2^{nd} nominal repetition as shown in FIG. 5), and transmits PUSCH starting from the second PRB, provided by mod(RB_start+RB_offset_FD, N_BWP_FD) in FD slot #2 with odd nominal repetition number (i.e., 3^{rd} nominal repetition as shown in FIG. 5). The UE transmits PUSCH starting from a first PRB, provided by RB_start in non-FD slot #1 with even nominal repetition number (i.e., 2^{nd} nominal repetition as shown in FIG. 5). The UE transmits PUSCH starting from a first PRB, provided by RB_start in non-FD slot #1 with even nominal repetition number (i.e., 0^{th} nominal repetition as shown in FIG. 5), and transmits PUSCH starting from the second PRB, provided by mod(RB_start+RB_offset, N_BWP) in in non-FD slots with odd nominal repetition number (i.e., 1^{st} nominal repetition as shown in FIG. 5).

Details described in all other embodiments of the present application (for example, details regarding frequency hopping for FD) are applicable for the embodiments of FIG. 5. Moreover, details described in the embodiments of FIG. 5 are applicable for all embodiments of FIGS. 1A-4C.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

What is claimed is:

1. A user equipment (UE) for wireless communication, comprising:
at least one memory; and
at least one processor coupled with the at least one memory and configured to cause the UE to:
receive configuration information regarding frequency hopping for a subset of symbols or slots of a plurality of available symbols or slots in a time domain; and
determine, based at least in part on the configuration information regarding frequency hopping, a frequency hopping operation in the subset of symbols or slots for at least one of a physical uplink control channel (PUCCH) resource and a physical uplink shared channel (PUSCH) resource.

2. The UE of claim 1, wherein the subset of symbols or slots is configured with a full duplex (FD) operation.

3. The UE of claim 1, wherein the subset of symbols or slots is determined by time division dual (TDD) configuration information.

4. The UE of claim 1, wherein the configuration 23 information regarding frequency hopping is carried in one or more of:
a first PUCCH resource configured for symbols or slots outside of the subset of symbols or slots; or
a second PUCCH resource configured for symbols or slots within the subset of symbols or slots.

5. The UE of claim 1, wherein the configuration information regarding frequency hopping includes at least one of:
a starting physical resource block (PRB) for a first hop within the subset of symbols or slots; or
a second hop PRB for a second hop within the subset of symbols or slots.

6. The UE of claim 5, wherein, during determining the frequency hopping operation, the at least one processor is configured to cause the UE to determine the starting PRB and the second hop PRB based at least in part on at least one of:
a starting PRB configured for symbols or slots outside of the subset of symbols or slots;
a second hop PRB configured for the symbols or slots outside of the subset of symbols or slots; and
a size of an uplink (UL) bandwidth part configured for symbols or slots within the subset of symbols or slots for UL transmission, in response to the symbols or slots within the subset of symbols or slots configured with a full duplex (FD) operation.

7. The UE of claim 1, wherein the at least one processor is configured to cause the UE to perform the frequency hopping operation in the subset of symbols or slots based at least in part on an indication in uplink (UL) grant information.

8. The UE of claim 1, wherein the configuration information regarding frequency hopping indicates enabling or disabling the frequency hopping operation for the subset of symbols or slots.

9. The UE of claim 8, wherein the at least one processor is configured to cause the UE to not perform the frequency hopping operation in symbols or slots within the subset of symbols or slots, in response to:
the configuration information regarding frequency hopping indicating disabling the frequency hopping operation for the subset of symbols or slots; and
the symbols or slots within the subset of symbols or slots being configured with a full duplex (FD) operation.

10. The UE of claim 1, wherein, during determining the frequency hopping operation, the at least one processor is configured to cause the UE to determine a list of frequency hopping offsets used for the frequency hopping operation in the subset of symbols or slots based at least in part on at least one of:
the configuration information regarding frequency hopping; or
another list of frequency hopping offsets used by symbols or slots outside of the subset of symbols or slots, and a size of an uplink (UL) bandwidth part configured for the symbols or slots within the subset of symbols or slots for UL transmission, in response to the symbols or slots within the subset of symbols or slots configured with a full duplex (FD) operation.

11. The UE of claim 1, wherein, during determining the frequency hopping operation, the at least one processor is configured to cause the UE to determine a starting physical resource block (PRB) for each hop in the subset of symbols or slots based at least in part on at least one of:
the configuration information regarding frequency hopping; or
a starting PRB indicated for symbols or slots outside of the subset of symbols or slots, and a size of an uplink (UL) bandwidth part configured for the symbols or slots within the subset of symbols or slots for UL transmission, in response to the symbols or slots within the subset of symbols or slots configured 6 with a full duplex (FD) operation.

12. The UE of claim 1, wherein the at least one processor is configured to cause the UE to transmit data on the at least one of the PUCCH resource and the PUSCH resource.

13. A network node for wireless communication, comprising:
at least one memory; and
at least one processor coupled with the at least one memory and configured to cause the network node to:
transmit configuration information regarding frequency hopping for a subset of symbols or slots of a plurality of available symbols or slots in a time domain; and
receive data on at least one of a physical uplink control channel (PUCCH) resource and a physical uplink shared channel (PUSCH) resource, wherein a frequency hopping operation in the subset of symbols or slots for the at least one of the PUCCH resource and the PUSCH resource is determined by the network node based at least in part on the configuration information regarding frequency hopping.

14. The network node of claim 13, wherein the subset of symbols or slots is configured with a full duplex (FD) operation.

15. The network node of claim 13, wherein the subset of symbols or slots is determined by time division dual (TDD) configuration information.

16. A processor for wireless communication, comprising:
at least one controller coupled with at least one memory and configured to cause the processor to:
receive configuration information regarding frequency hopping for a subset of symbols or slots of a plurality of available symbols or slots in a time domain; and
determine, based at least in part on the configuration information regarding frequency hopping, a frequency hopping operation in the subset of symbols or slots for at least one of a physical uplink control channel (PUCCH) resource and a physical uplink shared channel (PUSCH) resource.

17. The processor of claim 16, wherein the subset of symbols or slots is configured with a full duplex (FD) operation.

18. The processor of claim 16, wherein the subset of symbols or slots is determined by time division dual (TDD) configuration information.

19. The processor of claim 16, wherein the configuration information regarding frequency hopping is carried in one or more of:
a first PUCCH resource configured for symbols or slots outside of the subset of symbols or slots; or
a second PUCCH resource configured for symbols or slots within the subset of symbols or slots.

20. A method performed by a user equipment (UE), the method comprising:
receiving configuration information regarding frequency hopping for a subset of symbols or slots of a plurality of available symbols or slots in a time domain; and
determining, based at least in part on the configuration information regarding frequency hopping, a frequency hopping operation in the subset of symbols or slots for at least one of a physical uplink control channel (PUCCH) resource and a physical uplink shared channel (PUSCH) resource.
